(19) United States
(12) Patent Application Publication
(10) Pub. No.: US 2024/0422525 A1
(43) Pub. Date: Dec. 19, 2024

(54) MULTIPLE UNIVERSAL SUBSCRIBER IDENTITY MODULE (MUSIM) SWITCHING

(71) Applicant: Nokia Technologies Oy, Espoo (FI)

(72) Inventors: Srinivasan SELVAGANAPATHY, Bangalore (IN); Faranaz SABOURI-SICHANI, Aalborg (DK)

(21) Appl. No.: 18/698,439

(22) PCT Filed: Sep. 9, 2022
(86) PCT No.: PCT/FI2022/050603

§ 371 Date: Apr. 4, 2024

(30) Foreign Application Priority Data
Oct. 14, 2021 (IN) 202141046885

(51) Int. Cl. H04W 8/18; H04W 76/18; H04W 76/19

(52) U.S. Cl. CPC H04W 8/18; H04W 76/18; H04W 76/19

(57) ABSTRACT

Systems, methods, apparatuses, and computer program products for multiple universal subscriber identity module (MUSIM) switching are provided. One method may include declaring, by a user equipment (UE) having multiple universal subscriber identity modules (MUSIMs), radio link failure at a first network associated with one of the MUSIMs, determining a need to leave the first network to establish a connection to a second network associated with another one of the MUSIMs for a short duration, and storing a configuration for the first network to use for reestablishment at return of the user equipment to the first network.

### CROSS REFERENCE TO RELATED APPLICATION

This application claims priority from Indian provisional patent application no. 202141046885 filed on Oct. 14, 2021. The contents of this earlier filed application are hereby incorporated by reference in their entirety.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for multiple universal subscriber identity module (MUSIM) switching.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (ToT). With ToT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method including declaring, by a user equipment (UE) having multiple universal subscriber identity modules (MUSIMs), radio link failure at a first network associated with one of the multiple subscriber identity modules (MUSIMs). The method may also include determining, by the user equipment (UE), a is need to leave the first network to establish a connection to a second network associated with another one of the multiple subscriber identity modules (MUSIMs) for a short duration, and storing, by the user equipment (UE), a configuration for the first network to use for reestablishment at return of the user equipment to the first network.

An embodiment may be directed to a method including declaring, by a user equipment (UE) having multiple universal subscriber identity modules (MUSIMs), radio link failure at a first network associated with one of the multiple subscriber identity modules (MUSIMs). The method may also include determining, by the user equipment, a need to leave the first network to establish a connection to a second network associated with another one of the multiple subscriber identity modules (MUSIMs) with a preference to move to inactive state, and indicating, to the first network during reestablishment procedure, switching of the multiple subscriber identity modules (MUSIMs) with a preference to switch to the inactive state.

An embodiment may be directed to a method including, when a radio link failure procedure has started, determining, by a user equipment (UE) having multiple universal subscriber identity modules (MUSIMs), a need to switch from a first network associated with one of the multiple subscriber identity modules (MUSIMs) to establish a connection to a second network associated with another one of the multiple subscriber identity modules (MUSIMs). The method may also include deciding, by the user equipment (UE), to switch to the second network without waiting for a response from the first network to start the connection with the second network, and stopping a timer configured for waiting for the response from the first network and starting the connection with the second network.

An embodiment may be directed to an apparatus, which may include at least one processor and at least one memory comprising computer program code. The at least one memory and computer program code configured, with the at least one processor, to cause the apparatus at least to perform: declaring, by the apparatus which has multiple universal subscriber identity modules (MUSIMs), radio link failure at a first network associated with one of the multiple subscriber identity modules (MUSIMs), determining a need to leave the first network to establish a connection to a second network associated with another one of the multiple subscriber identity modules (MUSIMs) for a short duration, and storing a configuration for the first network to use for reestablishment at return of the apparatus to the first network.

An embodiment may be directed to an apparatus, which may include at least one processor and at least one memory comprising computer program code. The at least one memory and computer program code configured, with the at least one processor, to cause the apparatus at least to perform: declaring, by the apparatus which has multiple universal subscriber identity modules (MUSIMs), radio link failure at a first network associated with one of the multiple subscriber identity modules (MUSIMs), determining a need to leave the first network to establish a connection to a second network associated with another one of the multiple subscriber identity modules (MUSIMs) with a preference to move to inactive state, and indicating, to the first network during reestablishment procedure, switching of the multiple subscriber identity modules (MUSIMs) with a preference to switch to the inactive state.

An embodiment may be directed to an apparatus, which may include at least one processor and at least one memory comprising computer program code. The at least one memory and computer program code configured, with the at least one processor, to cause the apparatus at least to perform: when a radio link failure procedure has started, determining, by the apparatus which has multiple universal subscriber identity modules (MUSIMs), a need to switch from a first network associated with one of the multiple subscriber identity modules (MUSIMs) to establish a connection to a second network associated with another one of the multiple subscriber identity modules (MUSIMs), deciding to switch to the second network without waiting for a response from the first network to start the connection with the second network, and stopping a timer configured for waiting for the response from the first network and starting the connection with the second network.

An embodiment may be directed to an apparatus including means for declaring, by the apparatus which has multiple universal subscriber identity modules (MUSIMs), radio link failure at a first network associated with one of the multiple subscriber identity modules (MUSIMs). The apparatus may also include means for determining a need to leave the first network to establish a connection to a second network associated with another one of the multiple subscriber identity modules (MUSIMs) for a short duration, and means for storing a configuration for the first network to use for reestablishment at return of the apparatus to the first network.

An embodiment may be directed to an apparatus including means for declaring, by the apparatus which has multiple universal subscriber identity modules (MUSIMs), radio link failure at a first network associated with one of the multiple subscriber identity modules (MUSIMs). The apparatus may also include means for determining a need to leave the first network to establish a connection to a second network associated with another one of the multiple subscriber identity modules (MUSIMs) with a preference to move to inactive state, and means for indicating, to the first network during reestablishment procedure, switching of the multiple subscriber identity modules (MUSIMs) with a preference to switch to the inactive state.

An embodiment may be directed to an apparatus including, when a radio link failure procedure has started, means for determining, by the apparatus which has multiple universal subscriber identity modules (MUSIMs), a need to switch from a first network associated with one of the multiple subscriber identity modules (MUSIMs) to establish a connection to a second network associated with another one of the multiple subscriber identity modules (MUSIMs). The apparatus may also include means for deciding to switch to the second network without waiting for a response from the first network to start the connection with the second network, and means for stopping a timer configured for waiting for the response from the first network and starting the connection with the second network.

### BRIEF DESCRIPTION OF THE DRAWINGS

For proper understanding of example embodiments, reference should be made to the accompanying drawings, wherein:

FIG. 1 illustrates an example of radio link failure (RLF) procedure;

FIG. 2 illustrates an example signaling diagram in a case where a UE is leaving radio resource control (RRC) connection for a short duration, according to an example embodiment;

FIG. 3 illustrates an example signaling diagram in a case where a UE leaves RRC connection with a preference to move to inactive state, according to an example embodiment;

FIG. 4 illustrates an example signaling diagram in a case where a UE leaves a network without a reestablishment attempt or waiting for the network response, according to an example embodiment;

FIG. 5A illustrates an example flow diagram of a method, according to some example embodiments;

FIG. 5B illustrates an example flow diagram of a method, according to some example embodiments;

FIG. 5C illustrates an example flow diagram of a method, according to some example embodiments;

FIG. 6A illustrates an example block diagram of an apparatus, according to an embodiment; and

FIG. 6B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for multiple universal subscriber identity module (MUSIM) switching, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Some example embodiments discussed herein may address challenges to support MUSIM devices. For example, certain embodiments may provide systems and/or methods of MUSIM switching, e.g., for leaving a radio resource control (RRC) connection when radio link failure (RLF) is detected or predicted.

Radio access network (RAN) related MUSIM support is currently being considered. Some objectives of such support for MUSIM may include specifying possible enhancements to address collision due to reception of paging when a UE is in idle/inactive mode in both of the networks associated with respective subscriber identity modules (SIMs), for instance network A can be NR and network B can be either LTE or NR. Another objective may include specifying a mechanism for a UE to notify a first network (e.g., network A) of its switch from the first network to another network (e.g., network B), and specifying an applicable UE architecture, e.g., single-Rx/single-Tx, dual-Rx/single-Tx. A further objective may include specifying a mechanism for an incoming page to indicate to the UE whether the service is voice over LTE or voice over NR. It is noted that UE SIMs may belong to the same or different operators, and that a USIM can be a physical SIM or electronic (eSIM).

A multi-USIM device may have two (dual) or more (multiple) simultaneous 3GPP/3GPP2 network subscriptions with multiple corresponding international mobile subscriber identities (IMSI) in case of evolved packet system (EPS) or subscription permanent identifier (SUPI) in case of 5^{th} generation system (5GS). Each IMSI or SUPI may be associated with a particular subscription belonging to the same or different mobile network operator (MNO) or mobile virtual network operator (MVNO).

Generally, in today's mobile devices or UEs, the maximum number of supported USIMs is two. However, there may be some examples of devices supporting triple-SIM. With the introduction of eSIM, it is to be expected that some devices will arrive to the public market with support for more than two USIMs.

The UE's behaviour with respect to the simultaneous handling of multiple USIMs may depend on the UE's capabilities related to concurrent independent reception (Rx) and/or transmission (Tx) operations as discussed in the following. With single Rx/single Tx, the UE is capable of receiving traffic from one network and/or transmitting traffic to one network at a time (type 1). With dual Rx/single Tx, the UE is capable of simultaneously receiving traffic from two networks but is capable of transmitting to just one network at a time (type 2). With dual Rx/dual Tx, the UE is capable of simultaneously receiving and/or transmitting to/from two networks (type 3).

As an example, a switching notification procedure may assume that USIM-1 is active in network A (NTWK-A) and it may want to leave the RRC connection in NTWK-A for establishment of connection in network B (NTWK-B) or for the idle mode operation for USIM-2 in NTWK-B.

A switching notification process for leaving a network (NTWK-A) may be expected to include at least some of the following features. A UE assistance information message may be extended for switching notification in both network switching procedures for leaving RRC_CONNECTED state and without leaving RRC_CONNECTED state. The UE can be configured to provide assistance information for switching notification via other configuration of RRCReconfiguration message. A new RRC timer may be introduced for the “configured time”, used for the UE to leave RRC_CONNECTED without a response. It may be possible to configure the UE to wait for the network response (e.g., “infinite” waiting time). The UE might not be allowed to enter RRC_INACTIVE state if no network response message is received within a certain configured time period after the network switching notification message is sent.

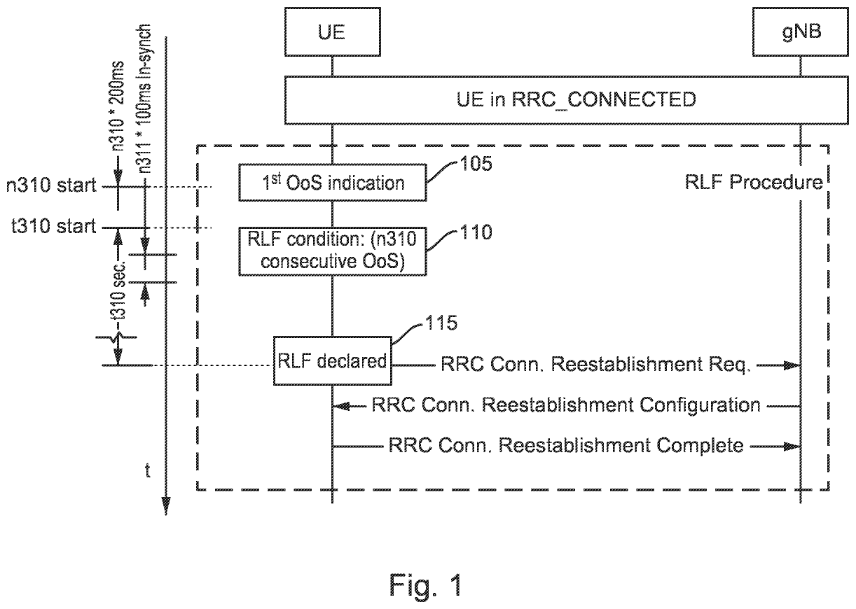

A radio link failure (RLF) assessment and declaration procedure may be based on the configured thresholds the UE can use to estimate the downlink radio link quality. FIG. 1 illustrates an example of the current procedure for RLF assessment and declaration. As illustrated in the example of FIG. 1, the UE runs radio link monitoring (RLM) measurements and, at 105, indicates out-of-sync (OoS) based on the defined Qout threshold and starts counting number of events related to this in the n310 counter. If the UE detects, as shown at 110, n310 consecutive OoS indications for a configurable number of frames (e.g., 20 frames (200 ms)), the UE starts the t310 timer while trying to get back in synchronization with the network. If the UE detects n311 consecutive in-sync indications estimated based on the Qin threshold for another configurable number of frames (e.g., 10 frames (100 ms)), prior to the t310 timer expiry, then the timer is stopped, and the link has not failed. However, if the t310 timer expires, RLF is declared at 115 and the UE requests RRC connection reestablishment.

In case of switching notification for leaving the serving network (e.g., NTWK-A), the UE will attempt to send UE assistance information (UAI) and start the RRC timer for network response. If the network does not provide the response before the expiry of the timer, the UE releases the RRC connection of the serving network (NTWK-A) and moves the UE to RRC idle state and starts its RRC connection in the network corresponding to its other USIM (e.g., NTWK-B). After completion of the activity at NTWK-B, if the UE application for USIM-1 (NTWK-A) still has pending data, the UE needs to establish the RRC connection from idle state. As the UE may leave NTWK-A in this scenario without notification received at NTWK-A, the RAN node of NTWK-A still maintains the RRC connection until the network releases the RRC connection based on its internal timer of any RLF detection mechanism at the network.

When the switching notification is triggered by the UE when it has predicted upcoming RLF at NTWK-A or RLF is already declared, some optimised UE behaviour is possible for faster re-establishment after return. Furthermore, providing additional information on return to the serving network (NTWK-A) can be beneficial for the network to release the old connection at appropriate time. Therefore, example embodiments described herein provide mechanisms to improve the switching notifications triggered while RLF is predicted or declared at the serving network (e.g., NTWK-A).

As will be discussed below, certain embodiments provide improvements to how the switching notification (e.g., UAI), which may be transmitted from the UE due to another high priority activity need at the RRC idle or RRC inactive network (e.g., NTWK-B), is triggered at different steps of RLF detection at the RRC connected network (NTWK-A).

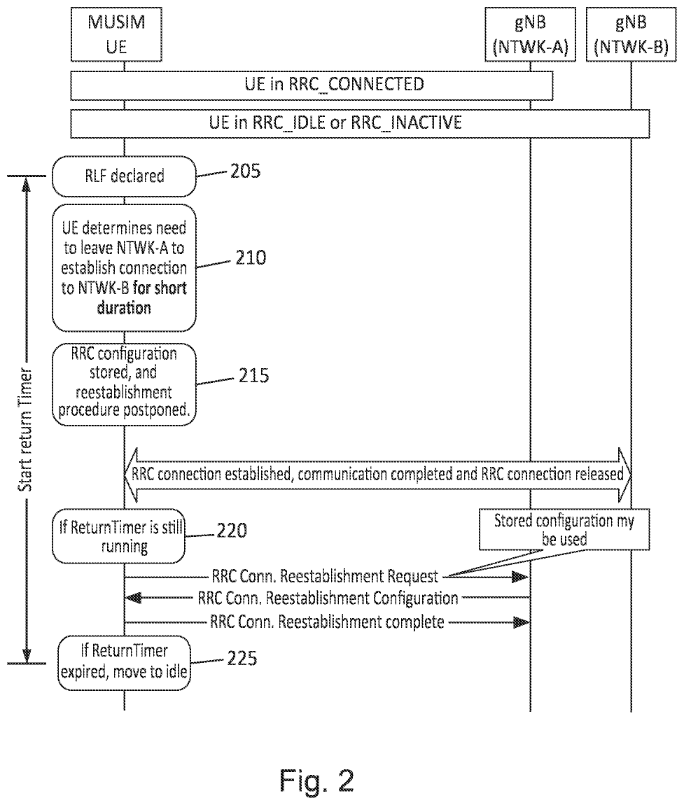

FIG. 2 illustrates an example signaling diagram, according to an example embodiment. In certain embodiments, as depicted at 205 in the example of FIG. 2, the UE may declare RLF at the RRC connected network (NTWK-A) and is undergoing re-establishment. If the switching notification is received from an application at the time of the UE starting cell reselection for re-establishment where the UE might have already stored the previous RRC configuration for re-establishment at the time of RLF declaration, the UE may abort the cell selection procedure in the RRC connected network (NTWK-A) and start the connection setup procedure in the RRC idle or inactive network (NTWK-B).

For example, as illustrated at 210, the UE may determine the need to leave the RRC connected network (NTWK-A) to establish a connected to the RRC idle or inactive network (NTWK-B) for a short duration. In one embodiment, if the reason for RRC connection setup in the RRC idle or inactive network (NTWK-B) is for a short duration, such as signalling message or busy indication, the UE may keep the stored RRC configuration for the RRC connected network (NTWK-A), as illustrated at 215, to use for re-establishment at return. In an embodiment, the UE may start a timer for triggering re-establishment at the RRC connected network (NTWK-A). The timer is denoted returnTimer in the example of FIG. 2 and its duration can be locally defined at the UE. In one embodiment, the UE can define the returnTimer to be slightly lower than the network configured wait time for leave without waiting for a network response. According to an embodiment, the UE may set the returnTimer to restart re-establishment considering the additional time needed for re-establishment from the time of switching back to the RRC connected network (NTWK-A). As one example, if the returnTimer is configured as N msec and if re-establishment procedure takes n seconds, the UE may start time for N-n for switching back and trigger re-establishment so that the network receives it before the timer of N expires.

In another embodiment, the returnTimer may be configured by the RRC connected network (NTWK-A). If the UE completes communication and the RRC connection is released from the the RRC idle or inactive network (NTWK-B) as shown at 218, and if the returnTimer is still running (i.e., before expiry of the timer) as shown at 220, then the UE may resume cell selection and continue with re-establishment procedure where the stored RRC configuration may be used. If, however, the returnTimer has expired, then the UE may move to idle state at 225. In one example embodiment, the RRC connected network (NTWK-A) will not release the UE context until the returnTimer expires, which enables the re-establishment after the return to be successful.

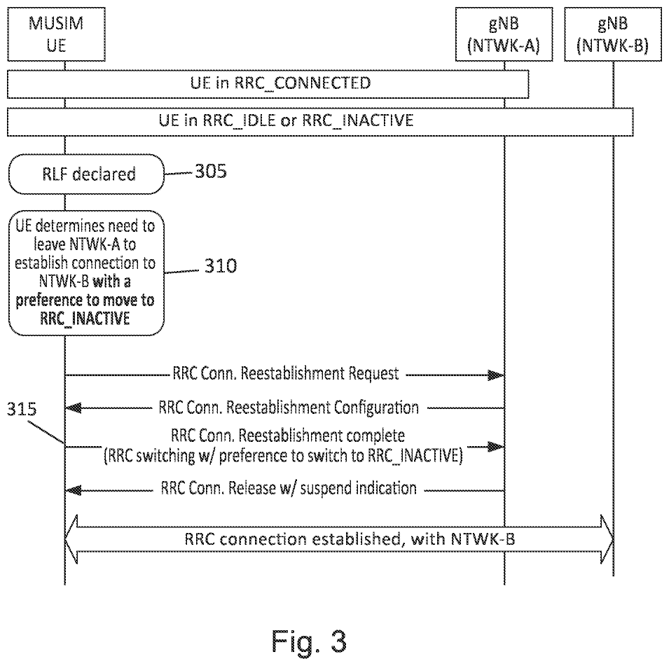

FIG. 3 illustrates an example signaling diagram, according to some embodiments. In the example of FIG. 3, at 305, the UE has declared RLF at the RRC connected network (NTWK-A) and is undergoing re-establishment. At 310, the UE may determine the need to leave the RRC connected network (NTWK-A) to establish connected to the RRC idle or inactive network (NTWK-B) with a preference to move to RRC inactive state. When the switching notification is triggered with the UE preference for RRC inactive state after leave and if the RLF is already declared, then the UE may proceed with the reestablishment procedure and, at 315, indicate the leave with RRC state preference in a RRC reestablishment request message so that gNB in the RRC connected network (NTWK-A) will move the UE to RRC inactive. In this case, the network may send RRC release with suspend configuration, for example, in Msg4 itself. In one embodiment, the UE can complete the RRC re-establishment procedure and provide the state-preference for leaving in Msg5 to obtain RRC release with suspend configuration. In another embodiment, the UE may add leave with RRC state preference already in Msg3 along with the reestablishment request. According to an embodiment, the gNB may send a RRC release with suspend configuration in response to the RRC reestablishment request in this case. The UE may switch to the RRC idle or inactive network (NTWK-B) after receiving the RRC connection release with suspend configuration after reestablishment. In some embodiments, the UE may also decide to trigger this procedure depending on the timer configured for network response for switching notification.

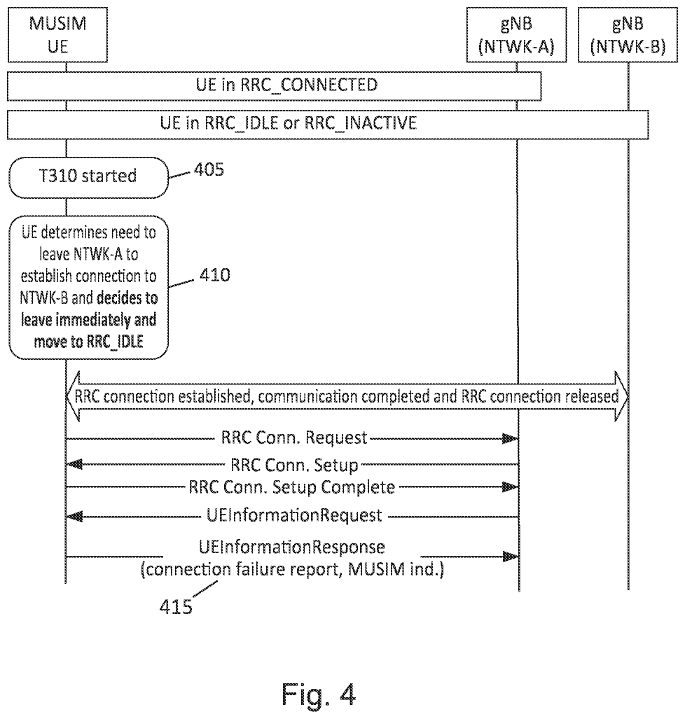

FIG. 4 illustrates an example signaling diagram, according to an example embodiment. In the example of FIG. 4, RLF is not declared but RLF procedure has started, for example, a T310 timer may be started at 405. As further illustrated in the example of FIG. 4, at 410, the UE may determine to leave the RRC connected network (NTWK-A) to establish a connection to the RRC idle or inactive network (NTWK-B), and may decide to do so immediately and move to RRC idle. For example, if the UE assistance information for leaving the RRC connected network (NTWK-A) is sent, the UE may decide to switch without waiting for the RRC connected network (NTWK-A) response and also abort or stop the timer for network response to start a RRC connection in the RRC idle or inactive network (NTWK-B). In this case, on return back to the RRC connected network (NTWK-A), the UE may trigger RRC connection request to start the connection from RRC idle state. According to an embodiment, at 415, the UE may transmit a UE information response, which is meant to carry RLF and connection failure report, and may include C-RNTI and a connection failure report with a reason indicating that ‘connection-dropped for MUSIM operation.’ In one embodiment, the network may use this information to classify the reason for connection failures for the UE contexts that were not properly released using the network initiated RRC connection release.

Therefore, example embodiments provide several mechanisms for handling a UE leaving RRC connection for MUSIM operation when RLF procedure is started or even when RLF is declared. In one embodiment, RRC connection reestablishment is triggered upon return from the RRC idle network (NTWK-B) to avoid connection failure at the RRC connected network (NTWK-A). Here, the UE may preserve RRC configuration for re-establishment purposes after return from short switching. In a further embodiment, if the UE intends to leave for RRC inactive, the UE may complete the RRC reestablishment procedure to indicate its state preference at reestablishment completion and receive RRC connection release with suspend configuration. According to yet a further embodiment, a MUSIM UE can include additional information in a UE information response to indicate a connection-drop for MUSIM operation.

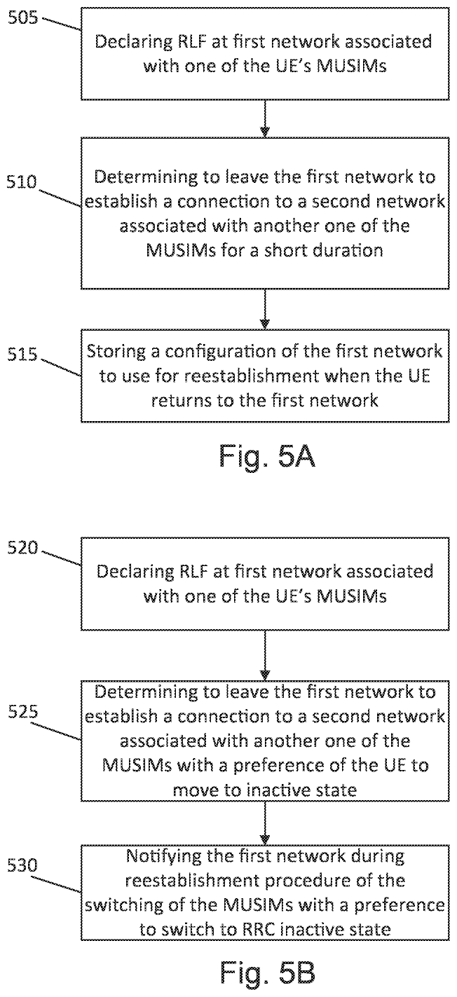

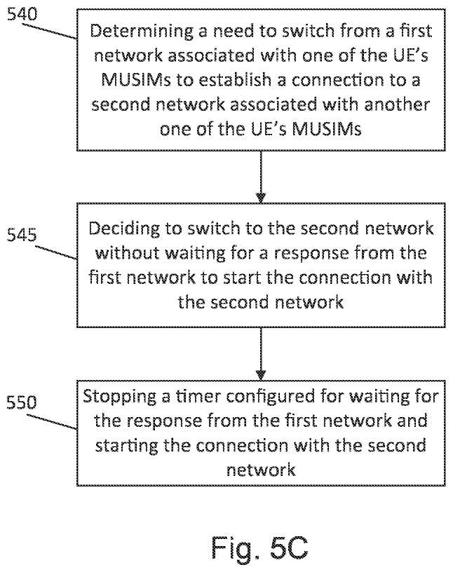

FIG. 5A illustrates an example flow diagram of a method for MUSIM switching, according to an example embodiment. For instance, the method of FIG. 5A may enable a device to leave a RRC connection when RLF is detected or predicted. In certain example embodiments, the flow diagram of FIG. 5A may be performed by a communication device in a communications system, such as LTE or 5G NR. For instance, in some example embodiments, the communication device performing the method of FIG. 5A may include a UE, sidelink (SL) UE, wireless device, mobile station, IoT device, UE type of roadside unit (RSU), other mobile or stationary device, or the like. In one embodiment, the method of FIG. 5A may be performed by a MUSIM device or MUSIM UE, i.e., a user equipment having multiple USIMs.

As illustrated in the example of FIG. 5A, at 505, a UE having MUSIMs declaring RLF at a first network associated with one of the MUSIMs. In an embodiment, the first network may be a RRC connected network, such as NTWK A illustrated in the examples of FIGS. 2-4. The method may also include, at 510, determining, by the UE, a need to leave the first network to establish a connection to a second network associated with another one of the MUSIMs for a short duration. For instance, the UE may decide to switch to the second network for a short duration due to reasons such as signaling a message or busy indication. In an embodiment, the second network may be a RRC idle or inactive network, such as NTWK B illustrated in the examples of FIGS. 2-4. According to an embodiment, the determining 510 may include receiving, from an application, a switching notification when the UE is starting cell reselection for reestablishment with the first network, aborting the cell reselection procedure with the first network, and starting the connection setup procedure with the second network.

As also illustrated in the example of FIG. 5A, the method may include, at 515, storing a configuration of the first network to use for reestablishment when the UE returns to the first network. In other words, when the connection setup (e.g., RRC connection setup) in the second network is for a short duration, the UE may keep the RRC configuration for the first network in order to use for reestablishment at return to the first network.

In some embodiments, the method may also include starting a timer (e.g. returnTimer) for triggering reestablishment at the first network. According to an embodiment, the timer may be defined by the UE to be lower than a network configured wait time for leaving the first network without waiting for a network response. Alternatively, or additionally, the timer may be configured by the first network. In certain embodiments, when the timer is still running when the UE completes communication and releases the connection with the second network, the method may include resuming the cell reselection procedure for reestablishment with the first network using the stored configuration of the first network. In one example embodiment, when the timer is configured by the first network, the UE context will not be released by the first network until the timer expires.

FIG. 5B illustrates an example flow diagram of a method for MUSIM switching, according to an example embodiment. For instance, the method of FIG. 5B may enable a device to leave a RRC connection when RLF is detected or predicted. In certain example embodiments, the flow diagram of FIG. 5B may be performed by a communication device in a communications system, such as LTE or 5G NR. For instance, in some example embodiments, the communication device performing the method of FIG. 5B may include a UE, sidelink (SL) UE, wireless device, mobile station, IoT device, UE type of roadside unit (RSU), other mobile or stationary device, or the like. In one embodiment, the method of FIG. 5B may be performed by a MUSIM device or MUSIM UE, i.e., a user equipment having multiple USIMs.

As illustrated in the example of FIG. 5B, the method may include, at 520, a UE having MUSIMs declaring RLF at a first network associated with one of the MUSIMs. In an embodiment, the first network may be a RRC connected network, such as NTWK A illustrated in the examples of FIGS. 2-4. According to an embodiment, the method may include, at 525, determining, by the UE, a need to leave the first network to establish a connection to a second network associated with another one of the MUSIMs with a preference to move to inactive state. In an embodiment, the second network may be a RRC idle or inactive network, such as NTWK B illustrated in the examples of FIGS. 2-4. According to an embodiment, the method may include, at 530, indicating or notifying, to the first network during reestablishment procedure, the switching of the MUSIMs with a preference to switch to RRC inactive state. Therefore, if the switching notification is triggered with the UE preference for RRC inactive state, the gNB in the first network can move the UE to the RRC inactive state. For example, the indicating 530 may include indicating the preference in a connection setup complete message (e.g., Msg5) or indicating the preference in a scheduled uplink (e.g., PUSCH) transmission (e.g., Msg3) along with a reestablishment request.

In one embodiment, the method may also include receiving, from the first network, a connection release message with a suspend configuration indication. In an embodiment, the connection release message may be received with the suspend configuration indication in a contention resolution message (e.g., Msg4). According to one embodiment, the method may include switching to the second network after receiving the connection release message with the suspend configuration indication after reestablishment. In an embodiment, the method may include the UE deciding to trigger the switching based on on a timer configured for waiting for a network response for the switching.

FIG. 5C illustrates an example flow diagram of a method for MUSIM switching, according to an example embodiment. For instance, the method of FIG. 5C may enable a device to leave a RRC connection when RLF is detected or predicted. In certain example embodiments, the flow diagram of FIG. 5C may be performed by a communication device in a communications system, such as LTE or 5G NR. For instance, in some example embodiments, the communication device performing the method of FIG. 5C may include a UE, sidelink (SL) UE, wireless device, mobile station, IoT device, UE type of roadside unit (RSU), other mobile or stationary device, or the like. In one embodiment, the method of FIG. 5C may be performed by a MUSIM device or MUSIM UE, i.e., a user equipment having multiple USIMs.

As illustrated in the example of FIG. 5C, the method may include, when a RLF procedure has started, at 540, determining, by the UE having MUSIMs, a need to switch from a first network associated with one of the MUSIMs to establish a connection to a second network associated with another one of the MUSIMs. In other words, according to this embodiment, RLF has not been declared but the RLF procedure has started, for example, with the T310 being started (e.g., after receiving a certain number of out-of-sync indications). In an embodiment, the first network may be a RRC connected network, such as NTWK A illustrated in the examples of FIGS. 2-4. According to an embodiment, the second network may be a RRC idle or inactive network, such as NTWK B illustrated in the examples of FIGS. 2-4.

As further illustrated in the example of FIG. 5C, the method may include, at 545, deciding, by the UE, to switch to the second network without waiting for a response from the first network to start the connection with the second network. Then, at 550, the method may include aborting or stopping a timer configured for waiting for the response from the first network and starting the connection with the second network. In this embodiment, upon returning to the first network, the method may include the UE transmitting a connection request to the first network to start a connection from an idle state. According to an embodiment, the method may include transmitting, to the first network, a UE information response that may include a connection failure report with a reason indicating that the connection dropped for MUSIM operation and a C-RNTI. The first network may then use this information to classify the reason for the connection failure(s) for the UE contexts that were not properly released using a network initiated connection release.

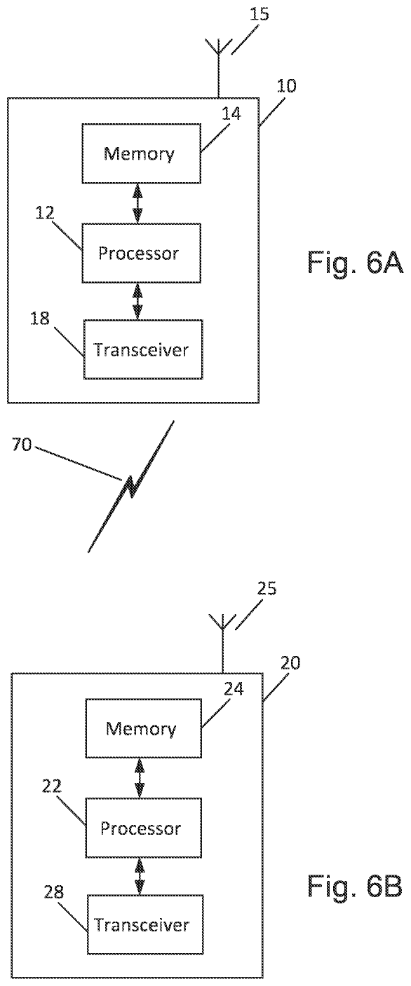

FIG. 6A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 6A.

As illustrated in the example of FIG. 6A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 6A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-5, or any other method described herein. In some embodiments, as discussed herein, apparatus 10 may be configured to perform a procedure relating to MUSIM switching, e.g., that can enable a device to leave a RRC connection when RLF is detected or predicted, for example.

FIG. 6B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 6B.

As illustrated in the example of FIG. 6B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-5, or any other method described herein. For example, in an embodiment, apparatus 20 may be controlled to perform a process relating to MUSIM switching, e.g., that can enable a device to leave a RRC connection when RLF is detected or predicted, as described in detail elsewhere herein.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments are configured to provide methods, apparatuses and/or systems that enable MUSIM switching. As such, some embodiments provide mechanism for handling a UE leaving a RRC connection for MUSIM operation when RLF procedure is started or even when RLF is declared. For instance, certain embodiments can trigger RRC connection reestablishment on return of the UE to the RRC connected network from another network to avoid connection failure at the RRC connected network. Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-51. (canceled)

52. An apparatus, comprising:
at least one processor; and
at least one memory including computer program code;
the at least one memory and the computer program code configured to, with the at least one processor, cause the apparatus at least to:
when a radio link failure procedure has started, determine, by the apparatus which has multiple universal subscriber identity modules (MUSIMs), a need to switch from a first network associated with one of the multiple subscriber identity modules (MUSIMs) to establish a connection to a second network associated with another one of the multiple subscriber identity modules (MUSIMs);
decide to switch to the second network without waiting for a response from the first network to start the connection with the second network; and
stop a timer configured for waiting for the response from the first network and start the connection with the second network.

53. The apparatus of claim 52, wherein, upon returning to the first network, the apparatus is further caused to:
transmit a connection request to the first network to start a connection from an idle state.

54. The apparatus of claim 53, wherein the connection request comprises a radio resource control connection request.

55. The apparatus of claim 52, wherein the apparatus is further caused to:
transmit, to the first network, a user equipment information response comprising a connection failure report with a reason indicating that connection dropped for multiple universal subscriber identity module (MUSIM) operation.

56. The apparatus of claim 55, wherein the user equipment information response further comprises information associated with the radio link failure.

57. The apparatus of claim 55, wherein the user equipment information response further comprises information associated with the one of the MUSIM identity.

58. The apparatus of claim 55, wherein the user equipment information response further comprises a cell radio network temporary identifier (C-RNTI).

59. The apparatus of claim 52, wherein the user equipment information response is transmitted in response to receiving a user equipment information request message.

60. A method, comprising:
when a radio link failure procedure has started, determining, by a user equipment (UE) having multiple universal subscriber identity modules (MUSIMs), a need to switch from a first network associated with one of the multiple subscriber identity modules (MUSIMs) to establish a connection to a second network associated with another one of the multiple subscriber identity modules (MUSIMs);
deciding, by the user equipment (UE), to switch to the second network without waiting for a response from the first network to start the connection with the second network; and
stopping a timer configured for waiting for the response from the first network and starting the connection with the second network.

61. The method of claim 60, wherein, upon returning to the first network, the method comprises the user equipment transmitting a connection request to the first network to start a connection from an idle state.

62. The method of claim 61, wherein the connection request comprises a radio resource control connection request.

63. The method of claim 60, further comprising: transmitting, to the first network, a user equipment information response comprising a connection failure report with a reason indicating that connection dropped for multiple universal subscriber identity module (MUSIM) operation.

64. The method of claim 63, wherein the user equipment information response further comprises information associated with the radio link failure.

65. The method of claim 63, wherein the user equipment information response further comprises information associated with the one of the MUSIM identity.

66. The method of claim 63, wherein the user equipment information response further comprises a cell radio network temporary identifier (C-RNTI).

67. The method of claim 60, wherein the user equipment information response is transmitted in response to receiving a user equipment information request message.
